(19) United States
(12) Patent Application Publication
(10) Pub. No.: US 2015/0128819 A1
(43) Pub. Date: May 14, 2015

(54) CAN DECORATOR MACHINE INK STATION ASSEMBLY

(71) Applicant: STOLLE MACHINERY COMPANY, LLC, Centennial, CO (US)

(72) Inventor: ANTHONY JOSEPH VELLA, AURORA, CO (US)

(73) Assignee: STOLLE MACHINERY COMPANY, LLC, Centennial, CO (US)

(21) Appl. No.: 14/078,570

(22) Filed: Nov. 13, 2013

(51) Int. Cl. B41F 31/00; B41F 17/00

(52) U.S. Cl. CPC B41F 31/005; B41F 17/006
USPC 101/36

(57) ABSTRACT

An ink station assembly including a limited number of rolls is provided. That is, An ink station assembly for a can decorator machine structured to decorate a plurality of cans, the ink station assembly includes an ink fountain and a limited number of rolls. The ink fountain is structured to provide a supply of ink. The limited number of rolls includes a first roll, a final roll, and a printing plate cylinder. The first roll is in liquid communication with the ink fountain. The first roll is also in ink film communication with the final roll. The final roil is in ink film communication with the printing plate cylinder.

### BACKGROUND

1. Field

The disclosed concept relates generally to machinery and, more particularly, to can decorator machines for decorating cans used in the food and beverage packaging industries. The disclosed concept also relates to ink station assemblies for can decorator machines.

2. Background Information

High speed continuous motion machines for decorating cans, commonly referred to as can decorator machines or simply can decorators, are generally well known.

FIG. 1 shows a can decorator 10 of the type disclosed, for example, in commonly assigned U.S. Pat. No. 5,337,659. The can decorator 10 includes an infeed conveyor 12, which receives cans 1 from a can supply (not shown) and directs them to arcuate cradles or pockets 14 along the periphery of spaced parallel rings secured to a pocket wheel 16. The pocket wheel 16 is fixedly secured to a continuously rotating mandrel carrier wheel 18, which in turn is keyed to a continuously rotating horizontal drive shaft 20. Horizontal spindles or mandrels (not shown), each being pivotable about its own axis, are mounted to the mandrel carrier wheel 18 adjacent its periphery. Downstream from the infeed conveyor 12, each spindle or mandrel is in closely spaced axial alignment with an individual pocket 14, and undecorated cans 1 are transferred from the pockets 14 to the mandrels. Suction applied through an axial passage of the mandrel draws the can 1 to a final seated position on the mandrel.

While mounted on the mandrels, the cans 1 are decorated by being brought into engagement with a blanket 22 (e.g., without limitation, a replaceable adhesive-backed piece of rubber) that is adhered to a blanket segment 24 of a multicolor printing unit 26. Thereafter, and while still mounted on the mandrels, the outside of each decorated can 1 is coated with a protective film of varnish applied by engagement with the periphery of an applicating roll (not shown) in an overvarnish unit 28. Cans 1 with decorations and protective coatings thereon are then transferred from the can decorator 10 for further processing.

Application of ink to the can 1 is accomplished as follows. Prior to engagement with an undecorated can 1, the blanket 22 engages a plurality of printing cylinders 60, each of which is associated with an individual ink station assembly 30 (six ink station assemblies 30 are shown in the example of FIG. 1). That is, as shown in FIG. 2, an ink station assembly 30 includes an ink fountain 32 and at least ten rolls. That is, the ink is transferred from one roll to another, generally, in the following order (ink is applied to selected rolls at the same time). Ink from the ink fountain 32 is applied to a fountain roll 40, then to a ductor roll 42, then to a distributor roll 44, then to a number of transfer rolls 46, 48, 50 as well as a number of oscillator rolls 52, 54, then to a number of form rolls 56, 58. Finally, ink from the form rolls 56, 58 is applied to the printing cylinder 60. The print cylinder 60 includes a number of printing plates (not shown) on which the ink is deposited as a controlled film of ink. The printing cylinder 60 applies the ink to the blanket 22 which, in turn, applies the ink to a can 1. That is, each ink station assembly 30 provides a different color ink and each printing cylinder 60 applies a different image segment to the blanket 22. All of these image segments combine to produce the main image. This main image is then transferred to undecorated cans 1.

One disadvantage of this configuration is that each roll in the ink train reduces the amount of solids in the ink. That is, the solids of the ink can be separated from the carrier as the ink is transferred from roll to roll resulting in little or no material reaching the printing plate. This is especially true if the ink requires a larger particle size, e.g. metallic inks, pearlescent inks, and other special inks. Another disadvantage is that the numerous rolls are each subject to wear and tear.

There is, therefore, room for improvement in can decorating machines and ink station assemblies.

### SUMMARY

These needs and others are met by embodiments of the disclosed concept, which provides an ink station assembly including a limited number of rolls. That is, an ink station assembly for a can decorator machine structured to decorate a plurality of cans, the ink station assembly includes an ink fountain and a limited number of rolls. The ink fountain is structured to provide a supply of ink. The limited number of rolls include a first roll, a final roll, and a printing plate cylinder. The first roll is in liquid communication with the ink fountain. The first roll is also in ink film communication with the final roll. The final roll is in ink film communication with the printing plate cylinder.

### BRIEF DESCRIPTION OF THE DRAWINGS

A full understanding of the disclosed concept can be gained from the following description of the preferred embodiments when read in conjunction with the accompanying drawings in which:

FIG. 1 is a side elevation view of a prior art can decorator machine.

FIG. 2 is a side elevation view of one of the ink station assemblies of FIG. 1, with one of the side plates removed.

FIG. 3 is an isometric view of a can decorator machine.

FIG. 4 is a cross-sectional view of an ink station assembly.

FIG. 5 is a partial isometric view of an ink station assembly.

FIG. 6 is an isometric view of a fountain blade assembly.

FIG. 7 is another isometric view of a fountain blade assembly.

FIG. 8 is an exploded view of a fountain blade assembly.

FIG. 9 is a cross-sectional view of a fountain blade assembly.

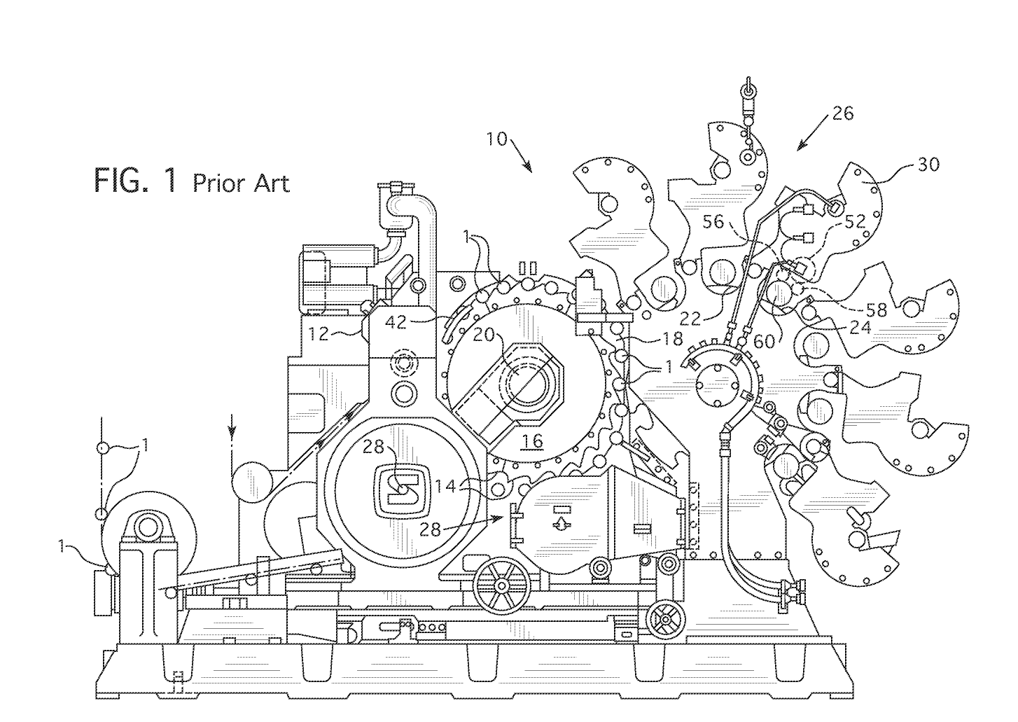

### DESCRIPTION OF THE PREFERRED EMBODIMENTS

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the statement that two or more parts or components “engage” one another shall mean that the elements exert a force or bias against one another either directly or through one or more intermediate elements or components.

As used herein, the word “unitary” means a component is created as a single piece or unit. That is, a component that includes pieces that are created separately and then coupled together as a unit is not a “unitary” component or body.

As used herein, the term “number” shall mean one or an integer greater than one (i.e., a plurality).

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are said to fit “snugly” together or “snuggly correspond.” In that situation, the difference between the size of the components is even smaller whereby the amount of friction increases. If the element defining the opening and/or the component inserted into the opening are made from a deformable or compressible material, the opening may even be slightly smaller than the component being inserted into the opening. This definition is further modified if the two components are said to “substantially correspond.” “Substantially correspond” means that the size of the opening is very close to the size of the element inserted therein; that is, not so close as to cause substantial friction, as with a snug fit, but with more contact and friction than a “corresponding fit,” i.e., a “slightly larger” fit. Further, as used herein, “loosely correspond” means that a slot or opening is sized to be larger than an element disposed therein. This means that the increased size of the slot or opening is intentional and is more than a manufacturing tolerance. Further, with regard to a surface formed by two or more elements, a “corresponding” shape means that surface features, e.g. curvature, are similar.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies.

As used herein, “at” means on or near.

As used herein, the term “can” refers to any known or suitable container, which is structured to contain a substance (e.g., without limitation, liquid; food; any other suitable substance), and expressly includes, but is not limited to, food cans, as well as beverage cans, such as beer and soda cans.

As used herein, the term “ink train” refers to the pathway by which ink is transferred through the ink station assembly and, in particular, from the ink fountain, through the various rolls of the ink station assembly to the printing plate cylinder.

As used herein, “ink film communication” means that a film of ink is transferred from one element to another while generally maintaining the distribution and configuration of ink in the film. That is, the ink is located in some locations and not others, and, the amount of ink is concentrated in some locations more than others. The communication of the ink film may be direct or indirect. That is, the ink film may be communicated from a first element directly to a final element, or, indirectly from a first element through a number of intermediate elements to a final element.

The specific elements illustrated in the drawings and described herein are simply exemplary embodiments of the disclosed concept. Accordingly, specific dimensions, orientations and other physical characteristics related to the embodiments disclosed herein are not to be considered limiting on the scope of the disclosed concept.

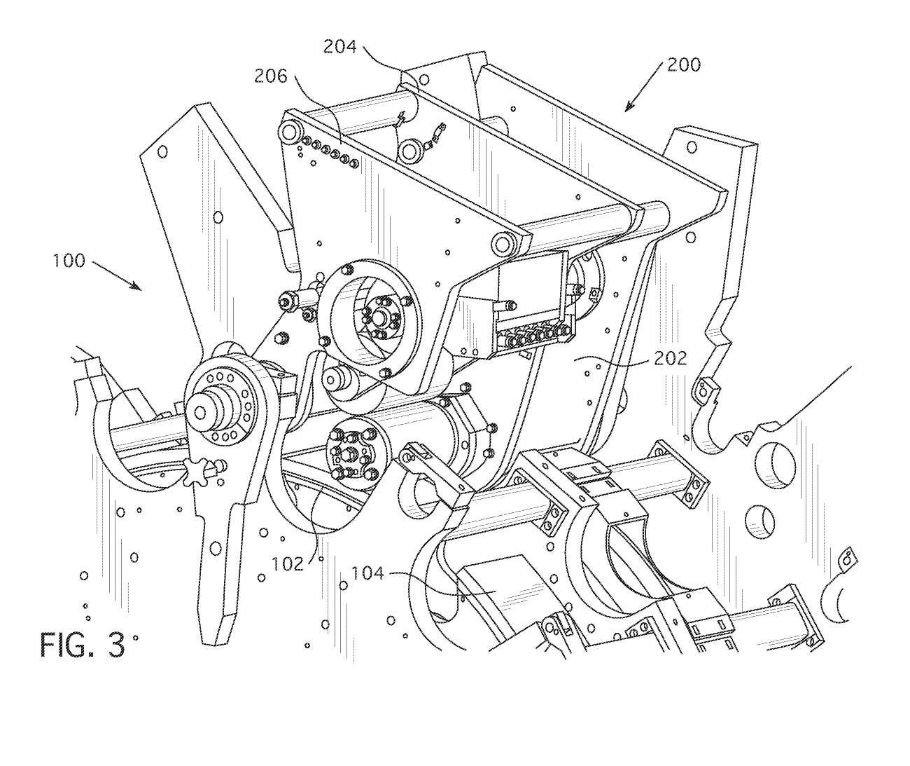

FIG. 3 shows a portion of a can decorator machine 100 including a number of ink station assemblies 200 in accordance with the disclosed concept. The can decorator machine 100 is structured to decorate (e.g., apply a desired ink-based image to the exterior of) a plurality of cans 1 (one can 1 is shown in simplified form in phantom line drawing in FIG. 3 for simplicity of illustration). Among other components, the can decorator machine 100, also sometimes referred to simply as a can decorator, includes a blanket wheel 102 and a number of blanket segments 104. Preferably, the blanket wheel 102 is structured to transfer an image associated with each image transfer segment 104 to a corresponding one of the cans 1. As previously noted, the can decorator 100 further includes a plurality of ink station assemblies 200. It will be appreciated that, while the can decorator 100 in the example shown and described herein includes eight ink station assemblies 200, that it could alternatively contain any known or suitable alternative number and/or configuration of ink station assemblies (not shown), without departing from the scope of the disclosed concept. It will further be appreciated that, for economy of disclosure and simplicity of illustration, only one of the ink station assemblies 200 will be shown and described in detail herein.

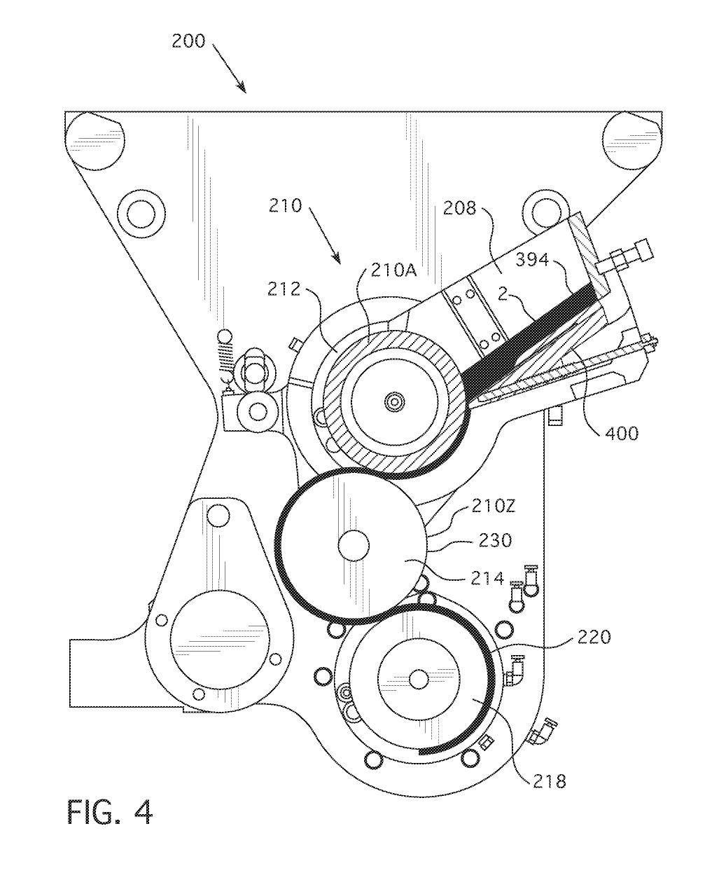

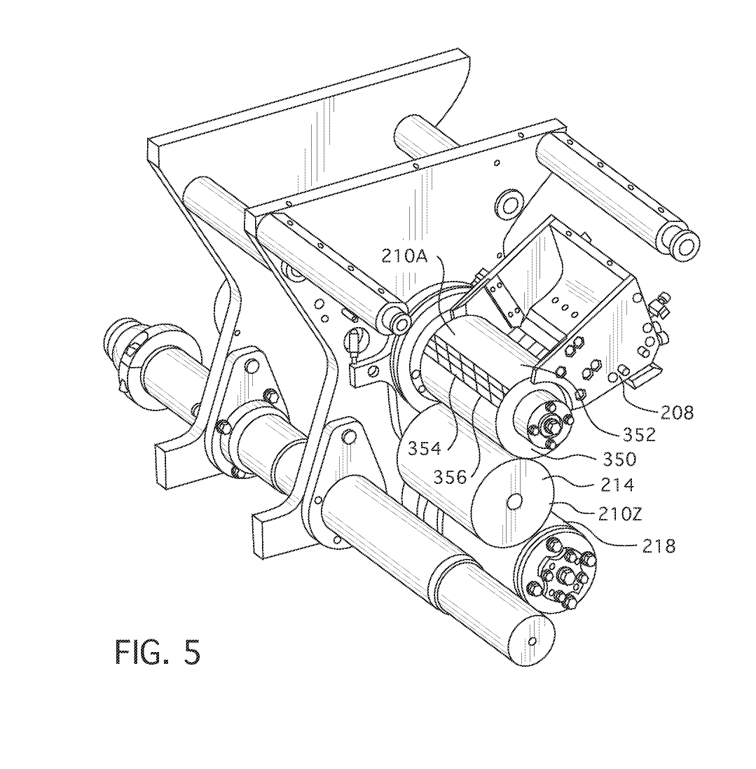

FIGS. 4 and 5 shows an exemplary embodiment of the ink station assembly 200. As is known, the ink station assembly 200 includes a drive assembly 202 (shown schematically), two side members 204, 206, an ink fountain assembly 208, and a number of rolls 210. The two side members 204, 206 are maintained is a spaced relation. The ink fountain assembly 208 is structured to provide a supply of ink 2 to a roll 210. Each roll 210 is rotatably coupled to, and disposed between, the two side members 204, 206. The drive assembly 202 is operatively coupled to a number of rolls 210 and is structured to cause the rolls 210 to rotate. That is, the drive assembly 202 causes a number of rolls 210 to rotate. Further, selected rolls 210 operatively engage each other so that the rotation of one roll 210 is transferred to an adjacent roll 210. Further, the ink station assembly 200 includes a printing plate cylinder 218. In an exemplary embodiment, the printing plate cylinder 218 is the final element in an ink train 220. As is known, the printing plate cylinder 218 includes a number of printing plates (not shown). The image that is to be printed on the cans 3 is disposed on, e.g. engraved in, each printing plate. Aspects of the final image, such as, hut not limited to, color density, are also a function of the distribution of ink in the film.

Generally, and in an exemplary embodiment, the ink station assembly 200 includes a limited number of rolls 210 (each roll, or type of roll, is described below). In another exemplary embodiment, the ink station assembly 200 includes a very limited number of rolls 210. The rolls 210 form an ink train 220 to the printing plate cylinder 218. That is, each roll 210 in the ink train 220 is in ink film communication with at least one adjacent roll 210. The number of rolls 210 includes a first roll 210A and a final roll 210Z. As set forth below, in different embodiments, there are no rolls 210, or, a number of rolls 210 between the first roll 210A and the final roll 210Z. The first roll 210A is in liquid communication with the ink fountain assembly 208. It is understood that, the ink 2 in the ink fountain assembly 208 is liquid; thus, as used herein, a roll 210 “in liquid communication with the ink fountain assembly 208” means that liquid ink 2 is applied to the roll 210. The first roll 210A is in ink film communication with the final roll 210Z. The final roll 210Z is in ink film communication with the printing plate cylinder 218. In an exemplary embodiment, the ink train 220 includes only the first roll 210A, the final roll 210Z, and the printing plate cylinder 218. The first roll 210A is also known as the fountain roll 211 in that the first roll 210A is in liquid communication with the ink fountain assembly 208.

That is, in an exemplary embodiment, the first roll 210A is an anilox roll 212 and the final roll 210Z is a form roll 214. The anilox roll 212 is discussed below. The form roll 214 includes resilient surface 230 which, in an exemplary embodiment, is made from rubber or a similar resilient or semi-resilient material. It is noted that use of a roll 210 with a resilient surface 230 reduces wear and tear on the anilox roll 212. Further, in an exemplary embodiment, neither the ink train 220 nor the ink station assembly 200 includes a ductor roll, a distributor roll, a transfer roll, or an oscillator roll. That is, in this embodiment, the ink station assembly 200 does not include any of a ductor roll, a distributor roll, a transfer roll, or an oscillator roll. In another exemplary embodiment, not shown, the ink train 220 and the ink station assembly 200 includes a second form roll (not shown).

In an exemplary embodiment, the drive assembly 202 is operatively coupled to the anilox roll 212 and the printing plate cylinder 218. The form roll 214 operatively engages the anilox roll 212 and rotates therewith. Further, in an exemplary embodiment, the form roll 214 further operatively engages the printing plate cylinder 218. Thus, the printing plate cylinder 218 rotates with the form roll 214.

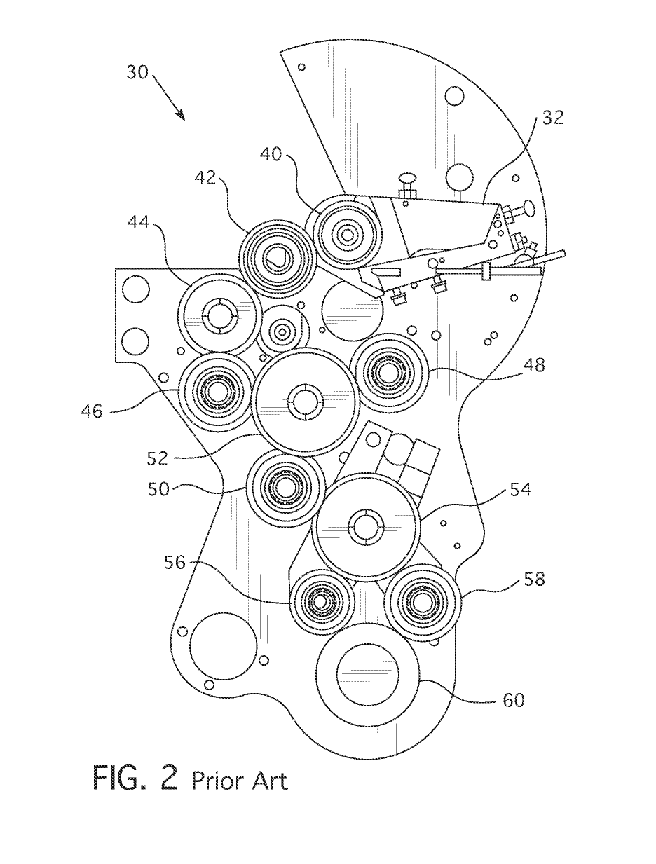

Accordingly, a method of decorating cans using the can decorator 100 machine (partially shown in FIG. 3) in accordance with the disclosed concept includes the steps of: (a) providing a number of the aforementioned ink station assemblies 200, (b) operating the drive assembly 202 to move a number of rolls 210 to transfer the ink 2 from the ink fountain assembly 208 over an ink train 220 including a first roll 210A and a final roll 210Z, (c) coating a printing plate of the printing plate cylinder 218 with ink 2 from the final roll 210Z, (d) rotating the blanket wheel 102 to bring the printing plate into contact with the blanket wheel 102 at or about a corresponding one of the blanket segments 104 (FIG. 2), (e) creating an image on the blanket wheel 102, (f) engaging the image blanket wheel 102 with a corresponding one of the cans 300, and (g) transferring the desired image to the can 300.

As shown in FIG. 5 the anilox roll 212 includes a substantially cylindrical body 350 including an outer surface 352. The anilox roll outer surface 352 includes a number of cells 354. The volume of a cell 354, or a group of adjacent cells, determines the amount of ink that is taken up by the anilox roll 212. The volume of the cell(s) 354, along with the fountain blade assembly 400, discussed below, determine the amount of ink that is transferred to any subsequent roll 210. Thus, the volume of the cell(s) 354 is the initial factor that determines the configuration of the ink film. The anilox roll cells 354 are defined by a number of cell walls 356. Each cell wall 356 has an outer surface 352 that forms a portion of the anilox roll outer surface 352. Thus, as used herein, the reference number “352” is used to indicate that portion of the anilox roll outer surface that is not part of the anilox cells 354 and which includes the outer surface between cells, i.e. the tops of the cell walls 356, as well as the surface of any portion of the anilox roll 212 wherein there are no cells 354. It is further understood that, as used herein, the “anilox roll outer surface 352” means the printing surface and does not include, e.g. the radial surface near the axial ends of the anilox roll 212 that are not part of the printing surface. That is, in an exemplary embodiment, the anilox roll 212 includes a radial surface (not shown) adjacent each axial end that is not part of the printing surface.

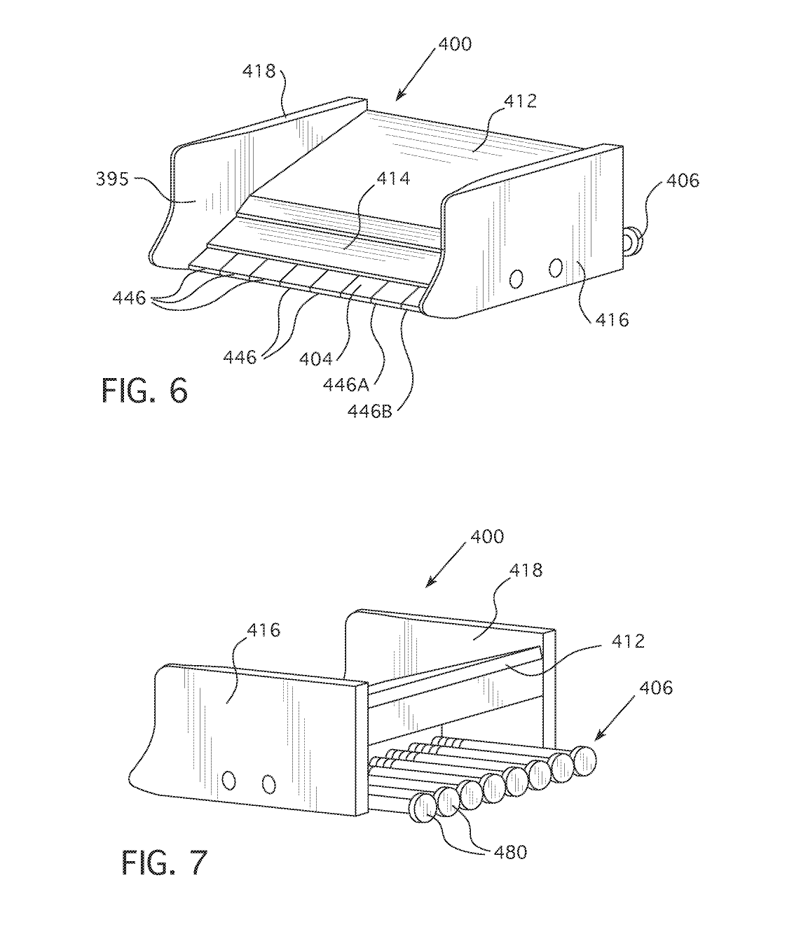

In an exemplary embodiment, the ink fountain assembly 208 includes a housing assembly 390 defining an enclosed space 392. As set forth below, certain elements of the fountain housing assembly 390 (FIG. 4) are also identified as elements of the fountain blade assembly mounting assembly 402 (FIG. 6). As is known, liquid ink is supplied to the ink fountain assembly 208 and is maintained for a limited time in the fountain enclosed space 392. In this configuration, the ink fountain assembly 208 includes a liquid ink supply 394. The housing assembly 390 further includes a number of seals 396 that are structured to engage the anilox roll 212. That is, the ink fountain assembly 208 is disposed adjacent the anilox roll 212 with the anilox roll 212 engaging the seals 394. Stated alternately, the anilox roll 212 is rotatably disposed adjacent to the ink fountain assembly 208 and is in liquid communication with the ink supply 394. As used herein, “in liquid communication,” when used in reference to an anilox roll 212 and an ink supply means that a liquid ink is applied to the anilox roll 212, filling the cells 354 thereof and coating the outer surface 352 thereof. Thus, the ink fountain assembly 208 is structured to apply the ink to the anilox roll cells 354 and to the anilox roll cell wall outer surface 352.

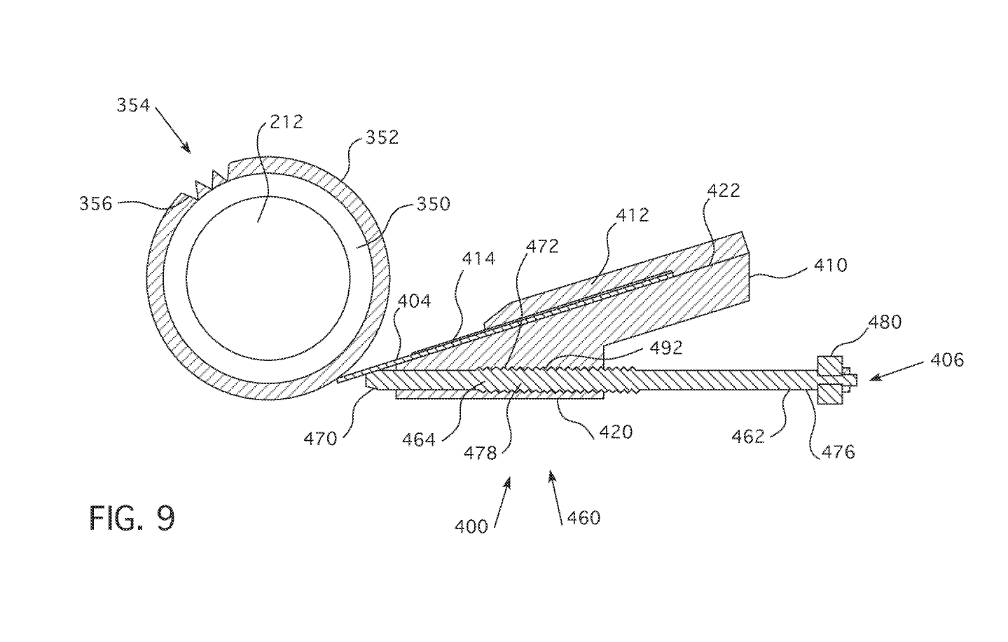

The ink fountain assembly 208 further includes a fountain blade assembly 400, as shown in FIGS. 6-9. The fountain blade assembly 400 is structured to remove ink from a portion of the anilox roll outer surface 352. As used herein, in reference to a fountain blade assembly removing ink from an anilox roll 212, the term “portion” means less than the whole. Further, as noted above, the “anilox roll outer surface 352” means the printing surface and does not include portions of the roll surface that are not part of the printing surface, e.g. the radial surface adjacent the axial ends of the anilox roll 212 that are not part of the printing surface. Thus, a prior art doctor blade that removes ink from the entire printing surface, but allows ink to remain on, e.g. the radial surface adjacent the axial ends of the anilox roll actually “removes ink from the entire anilox roll surface” That is, as used herein, to “remove ink from a portion of the anilox roll outer surface 352” means to remove ink from a limited amount of the printing surface.

The fountain blade assembly 400 includes a mounting assembly 402, a blade assembly 404, and an adjustment assembly 406. In an exemplary embodiment, as shown, the mounting assembly 402 includes a mounting body 410 (hereinafter “mounting body” is shortened to “mounting, e.g.,” “mounting 410”), a clamp plate 412, a backer plate 414, and two side plates 416, 418, as well as the number of seals 395 discussed above. As noted above, the fountain housing assembly 390 and the mounting assembly 402, as well as the mounting 410, are elements of the same construct and are given different names herein for the sake of discussion. It is further understood that in another embodiment, not shown, the fountain housing assembly 390 and the mounting assembly 402 are separate elements with the mounting assembly 402 coupled to the fountain housing assembly 390 adjacent the anilox roll 212.

In an exemplary embodiment, the mounting 410 includes a generally planar lower surface 420 and a generally planar upper surface 422. The mounting lower and upper surfaces 420, 422 are, in an exemplary embodiment, at an angle relative to each other. As shown, the angle is about 15 degrees. The clamp plate 412 is a substantially rigid, planar body 430 structured to be coupled to the mounting upper surface 422. The backer plate 414 is, in an exemplary embodiment, a planar body 432 made from resilient spring steel and is structured to enhance the bias of the blade assembly 404.

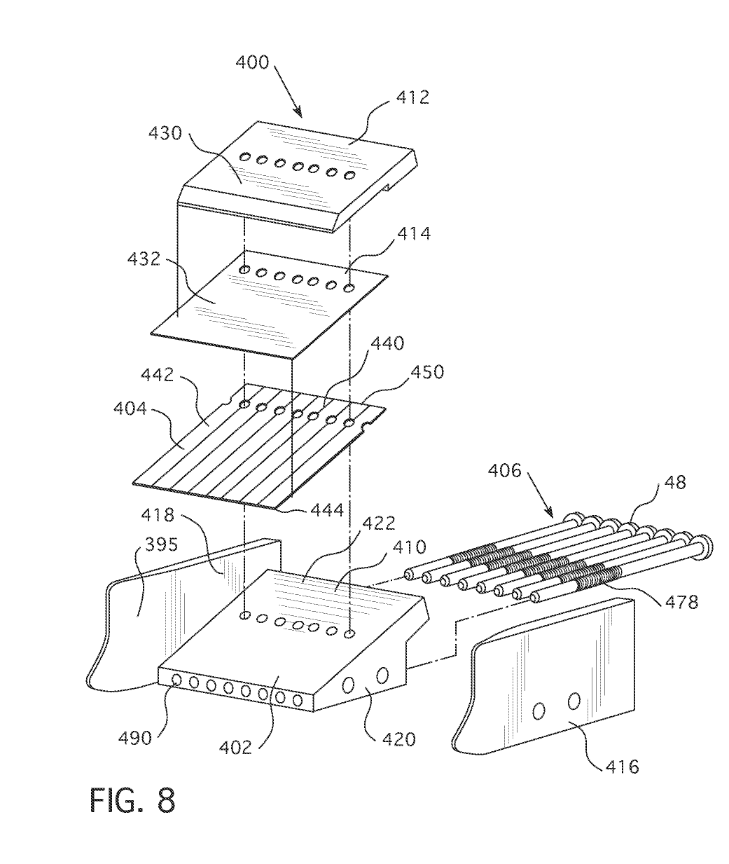

As shown in FIG. 8, the blade assembly 404 includes a blade 440 which is a generally planar, resilient body 442 having a first edge 444. The blade first edge 444 includes a plurality of adjustable portions 446. As set forth below, the blade 440 is disposed adjacent the anilox roll outer surface 352. Thus, the blade first edge adjustable portions 446 are structured to, and do, move between a first position, wherein each blade first edge adjustable portion 446 is spaced from the anilox roll outer surface 352, and a second position, wherein each blade first edge adjustable portion 446 engages from the anilox roll outer surface 352. As described further below, each blade first edge adjustable portion 446 is further structured to be disposed in a number of intermediate positions between the first and second positions.

In an exemplary embodiment, the blade 440 includes a number of elongated segments 450 disposed immediately adjacent each other. Each blade segment 450 includes one blade first edge adjustable portion 446. In another embodiment, not shown, the blade body 442 is a unitary body including parallel slits (not shown) extending inwardly from the blade first edge 444. That is, generally, the blade body 442 is similar to a comb, but wherein there is no, or a minimal, gap between the “teeth” of the comb. In another embodiment, not shown, the blade body 442 is a very resilient unitary body wherein a bias applied to one area of the blade first edge 444 is not significantly transmitted to another area of the blade first edge 444.

The adjustment assembly 406, in an exemplary embodiment, includes a number of adjustment devices 460. Each adjustment device 460 is associated with, and structured to move, one blade first edge adjustable portion 446 between the first and second positions. That is, in an exemplary embodiment, there is an equal number of adjustment devices 460 and blade first edge adjustable portions 446. Thus, each blade first edge adjustable portion 446 has one associated adjustment device 460. In an exemplary embodiment, and as shown in FIGS. and 9, the adjustment devices 460 include a number of elongated bodies 462 each with a movable coupling 464. Each adjustment device body 462 includes a first end 470, a medial portion 472 and a second end 476. Each adjustment device body first end 470 is structured to engage an associated blade segment 450. In an exemplary embodiment, each adjustment device body first end 470 is generally conical and tapered at an angle substantially similar to the angle between the mounting lower and upper surfaces 420, 422. Each adjustment device body medial portion 472 includes a threaded portion 478. The adjustment device body threaded portion 478 is the movable coupling 464, as described below. Each adjustment device body second end 476 includes an actuator which, in an exemplary embodiment, is a knob 480. Further, in an exemplary embodiment, not shown, each adjustment device body second end 476, and/or the adjustment device body medial portion 472, includes an indicia indicating a longitudinal measurement. Further, the mounting 410 includes tubular collars (not shown) disposed about the adjustment device body second end 476 that provides a structure to which the indicia may be compared.

Further, the mounting 410 defines a number of elongated passages 490. The mounting passages 490 extend, in an exemplary embodiment, generally parallel to the mounting lower surface 420. Each mounting passage 490 includes a threaded portion 492. The mounting passages 490 correspond to the adjustment device body 462 and the mounting passage threaded portion 492 is structured to be coupled to the adjustment device body threaded portion 478.

The fountain blade assembly 400 is assembled as follows. The blade 440 is disposed on the mounting upper surface 422 with the plane of the blade 440 substantially corresponding to the plane of the mounting upper surface 422. The backer plate 414 is disposed on the blade 440, and, the clamp plate 412 is disposed on the backer plate 414. The blade 440, backer plate 414, and clamp plate 412 are, in an exemplary embodiment, coupled by fasteners (not shown) that extend into the mounting 410. Each blade first edge adjustable portion 446, that is, each blade segment first edge 444, extends beyond the mounting upper surface 422. Further, the adjustment devices 460 are disposed in the mounting passages 490 with each adjustment device body threaded portion 478 threadably coupled to a mounting passage threaded portion 492. As noted above, in an exemplary embodiment, there are an equal number of blade segments 450 and adjustment devices 460. The mounting passages 490 are positioned so that each adjustment device 460 is generally aligned with a blade segment 450.

In this configuration, when the blade 440, and/or the blade segments 450, are disposed in a plane substantially parallel to the mounting upper surface 422, the blade first edge adjustable portions 446 are in their first positions. That is, when each blade first edge adjustable portion 446 is in the first position, the entire blade body 442 is generally parallel to the mounting upper surface 422. Each adjustment device 460 is moved to a position, e.g. rotated so that the threaded coupling advances the adjustment device 460 longitudinally, until the adjustment device body first end 470 contacts a blade first edge adjustable portion 446. Further longitudinal motion of the adjustment device 460 toward the blade first edge adjustable portions 446 causes the adjustment device body first end 470 to engage and move the associated blade first edge adjustable portion 446 toward the second position.

That is, the ink fountain assembly 208 and fountain blade assembly 400 is positioned so that the blade first edge adjustable portion 446, when in the first position, is spaced from the anilox roll outer surface 352. In an exemplary embodiment, the blade first edge adjustable portion 446, when in the first position, is spaced from the anilox roll outer surface 352 between about 0.010 inch and 0.020 inch or about 0.015 inch. Thus, when an adjustment device 460 is moved longitudinally toward the blade 440, the engagement of the adjustment device 460 with the associated blade first edge adjustable portion 446 causes the blade first edge adjustable portion 446 to move toward, and then into, the second position. It is understood that the advancement of the adjustment device 460 may be stopped at any position between the first and second positions. Further, as shown, and in an exemplary embodiment, each adjustment device body medial portion 472 extends from the mounting passage 490 on that a user may actuate the adjustment device 460, i.e. in the exemplary embodiment, by rotating the adjustment device 460.

Thus, at least one blade first edge adjustable portion 446 is disposed in a different position relative to another blade first edge adjustable portion 446. In this configuration, the amount of ink removed from the anilox roll outer surface 352 is controlled. That is, for example, one blade first edge adjustable portion 446A is positioned in the second position, whereby substantially all the ink on the portion of the anilox roll 212 that passes under that blade first edge adjustable portion 446A is removed. An adjacent blade first edge adjustable portion 446B, however, is in the first position; thus, little of the ink on the portion of the anilox roll outer surface 352 that passes under that blade first edge adjustable portion 446B is removed. In this manner, the amount of ink on the anilox roll outer surface 352, and therefore the amount of ink transferred to the first roll 210A and a final roll 210Z, is controlled. That is, in conjunction with the volume of the anilox cells 354, the fountain blade assembly 400 controls the amount of ink that comprises the ink film that is applied to any subsequent roll 210.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. An ink station assembly for a can decorator machine structured to decorate a plurality of cans, the ink station assembly comprising:
an ink fountain structured to provide a supply of ink;
a limited number of rolls, said limited number of rolls including a first roll, a final roll, and a printing plate cylinder;
wherein said first roll is in liquid communication with said ink fountain;
wherein said first roll is in ink film communication with said final roll; and
wherein said final roll is in ink film communication with said printing plate cylinder.

2. The ink station assembly of claim 1 wherein said limited number of rolls is a very limited number of rolls.

3. The ink station assembly of claim 1 wherein each said roll in said limited number of rolls is part of an ink train.

4. The ink station assembly of claim 3 wherein said ink train includes only said first roll, said final roll, and said printing plate cylinder.

5. The ink station assembly of claim 4 wherein said first roll is an anilox roll.

6. The ink station assembly of claim 5 wherein said final roll is a form roll.

7. The ink station assembly of claim 5 wherein said final roll includes a resilient surface.

8. The ink station assembly of claim 1 wherein said ink train does not include any of a ductor roll, a distributor roll, a transfer roll, or an oscillator roll.

9. The ink station assembly of claim 1 wherein said limited number of rolls includes two form rolls.

10. The ink station assembly of claim 1 wherein
said limited number of rolls includes an anilox roll; and
wherein each roll in direct ink film communication with said anilox roll includes a resilient surface.

11. A can decorator machine comprising:
a blanket including a number of blanket segments;
a number of ink station assemblies, each ink station disposed adjacent to said blanket and structured to apply ink to said blanket segments, each said ink station assembly including an ink fountain and a limited number of rolls;
said ink fountain structured to provide a supply of ink;
said limited number of rolls including a first roll, a final roll, and a printing plate cylinder;
wherein said first roll is in liquid communication with said ink fountain;
wherein said first roll is in ink film communication with said final roll; and
wherein said final roll is in ink film communication with said printing plate cylinder.

12. The can decorator machine of claim 11 wherein said limited number of rolls is a very limited number of rolls.

13. The can decorator machine of claim 11 wherein each said roll in said limited number of rolls is part of an ink train.

14. The can decorator machine of claim 13 wherein said ink train includes only said first roll, said final roll, and said printing plate cylinder.

15. The can decorator machine of claim 14 wherein said first roll is an anilox roll.

16. The can decorator machine of claim 15 wherein said final roll is a form roll.

17. The can decorator machine of claim 15 wherein said final roll includes a resilient surface.

18. The can decorator machine of claim 11 wherein said ink train does not include any of a ductor roll, a distributor roll, a transfer roll, or an oscillator roll.

19. The can decorator machine of claim 11 wherein said limited number of rolls includes two form rolls.

20. The can decorator machine of claim 11 wherein
said limited number of rolls includes an anilox roll; and
wherein each roll in direct ink film communication with said anilox roll includes a resilient surface.
